(19) United States
(12) Patent Application Publication
(10) Pub. No.: US 2022/0122213 A1
(43) Pub. Date: Apr. 21, 2022

(54) ELECTRIC VEHICLE RESCUE SYSTEM

(71) Applicant: IP VENUE, LLC, Albuquerque, NM (US)

(72) Inventors: Luis M. Ortiz, Albuquerque, NM (US); Kermit D. Lopez, Albuquerque, NM (US)

(21) Appl. No.: 17/512,407

(22) Filed: Oct. 27, 2021

Related U.S. Application Data
(63) Continuation-in-part of application No. 16/819,135, filed on Mar. 15, 2020, now Pat. No. 11,188,995.
Application No. 16/819,135 is a continuation of application No. 15/792,147, filed on Oct. 24, 2017, now Pat. No. 10,628,904.
Application No. 15/792,147 is a continuation of application No. 15/080,705, filed on Mar. 25, 2016, now Pat. No. 9,846,918.
(60) Provisional application No. 62/138,688, filed on Mar. 26, 2015.

(51) Int. Cl. G06Q 50/30; G07C 5/08; G07C 5/00; G06Q 20/14; H02J 7/00; B60L 53/14; H02J 7/34

(52) U.S. Cl. CPC G06Q 50/30; G07C 5/0808; G07C 5/008; G06Q 20/14; B60P 3/12; B60L 53/14; H02J 7/342; H02J 7/0013; H02J 7/00

(57) ABSTRACT

A system for electric car rescue and a method of operating the system can include a rescue vehicle that includes a mobile platform, the mobile platform deployable for retrieving a disabled electric vehicle thereon for transportation of the disabled electric vehicle. A charging unit can be associated with the mobile platform and can connect to the disabled electric vehicle for recharging of the disabled electric vehicle during a transportation of the disabled electric vehicle on the mobile platform. The rescue vehicle can be an autonomous vehicle, a semi-autonomous vehicle, or a non-autonomous vehicle.

### CROSS-REFERENCE TO RELATED PATENT APPLICATIONS

This patent application is a continuation-in-part of U.S. patent application Ser. No. 16/819,135 entitled “Electric Vehicle Rescue System,” which was filed on Mar. 15, 2020 and is incorporated herein by reference in its entirety. U.S. patent application Ser. No. 16/819,135 in turn is a continuation of U.S. patent application Ser. No. 15/792,147 entitled “Electric Vehicle Rescue System,” which was filed on Oct. 24, 2017 and issued as U.S. Pat. No. 10,628,904 on Apr. 21, 2020, the disclosures of which are incorporated herein by reference in their entirety.

U.S. patent application Ser. No. 15/792,147 is a continuation of U.S. patent application Ser. No. 15/080,705, entitled “Electric Vehicle Rescue System,” which was filed on Mar. 25, 2016, and is incorporated herein by reference in its entirety, and which issued as U.S. Pat. No. 9,846,918 on Dec. 19, 2017. U.S. Pat. No. 15/080,805 is also incorporated herein by reference in its entirety.

U.S. patent application Ser. No. 15/080,705 is a continuation of and claims priority to U.S. Provisional Patent Application Ser. No. 62/138,688, filed Mar. 26, 2015, entitled “Electric Vehicle Rescue System”, which is hereby incorporated by reference in its entirety. This patent application therefore claims priority to and the benefit of U.S. Provisional Patent Application Ser. No. 62/138,688, filed Mar. 26, 2015.

### TECHNICAL FIELD

Embodiments are related to the field of electric vehicles. Embodiments also relate to systems and methods for charging, analyzing, and otherwise providing roadside assistance to stranded electric vehicles.

### BACKGROUND

Electric vehicles are becoming widely accepted as a means of personal transportation. Vehicle manufacturers such as GM, Tesla Inc., BMW, and others have been experiencing growth in sales and the market for electric vehicles. The concern voiced by many potential buyers of electric vehicles is that they may not be able to make it to the next charging station. Although several entities are working towards deploying charging stations throughout metropolitan areas, electric vehicle owners or would be owners still have concerns about running out of power, particularly when driving extensive distances.

There are companies that are providing rescue services to stranded electric vehicles using a flatbed (e.g., a flatbed trailer or a flatbed integrated with a vehicle) and winch to retrieve the electric vehicle onto the flatbed. A problem is that the electric vehicle will still be without power once it is towed to its destination.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide an EV (Electric Vehicle) rescue vehicle, system and method that can include the use of a mobile platform including a winch and a ramp.

It is another aspect of the embodiments to provide an EV (Electric Vehicle) rescue vehicle, system and method with a mobile platform that is deployable for retrieving a disabled EV (i.e., the “rescued vehicle”) thereon with the winch and the ramp and for transportation of the EV.

It is another aspect of the embodiments to provide a charging unit in association with the mobile platform for connection to and charging of the EV, either on location or during transport of the EV.

It is yet another aspect of the embodiments to provide for a systems analysis in association with the EV rescue system for testing the functionality of systems and components of the EV, wherein the results of an analysis can be provided to customers.

It is another aspect of the embodiments that the mobile platform can be provided as a rescue vehicle in the form of a trailer pulled by another vehicle (e.g., pulled by a heavy duty truck) or integrated with another vehicle (e.g., the truck).

It is also an aspect of the embodiments that the rescue vehicle carry passengers associated with the EV as the EV is being transported, charged, and/or analyzed.

It is also an aspect of the embodiments that a roadside assistance service be provided including a network of independent providers connected to stranded EV customers using a mobile apple via a data network and based on the physical location of the independent providers and the stranded customer/user making a rescue request.

It is also an aspect of the embodiments that the rescue vehicle include means for charging batteries associated with the rescue vehicle or the rescued vehicle.

It is a further aspect of the embodiments to provide at least one PV (Photovoltaic) panel that is associated with the mobile platform to charge batteries when a vehicle is not being transported.

It is still another aspect of the embodiments to provide a generator associated with wheels of the rescue vehicle, which can generate power as the rescue vehicle moves on a road or highway while transporting the aforementioned rescued vehicle.

The aforementioned aspects and other objectives and advantages can now be achieved as described herein. In an embodiment, a system for electric vehicle rescue can include a mobile platform comprising a winch and a ramp. The mobile platform can be deployed for retrieving an electric vehicle thereon with the winch and the ramp and for transportation of the electric vehicle. The system can also include a charging unit associated with the mobile platform for connection to the electric vehicle and for recharging of the electric vehicle.

In an embodiment, a data processing apparatus can be provided that can analyze and test the functionality of systems and components of the electric vehicle. The data processing apparatus can communicate electronically with the charging unit and the electric vehicle and can generate an electronic report indicative of the result of the analysis and testing.

In an embodiment, the mobile platform can be a trailer pulled by another vehicle. In another embodiment, the mobile platform can be integrated with another vehicle. In some example embodiments, the another vehicle can be adapted to carry passengers associated with the electric vehicle as the electric vehicle is being charged by the charging unit. In another example embodiment, the aforementioned data processing apparatus can be implemented as a remote server in communication with a data network and wherein the data network communicates with the electric vehicle.

In an embodiment, a method for providing an electric vehicle rescue vehicle, can involve steps, operations or instructions including: connecting a user of a client device to a remote server to request one or more vehicle rescue services; determining a location of the client device of the user and a location of the nearest EVR (Electric Vehicle Rescue) unit with respect to the location of the client device, in response to the user's request for a vehicle rescue service; and directing or instructing the nearest EVR unit to drive to the location of the user.

In an embodiment, steps, operations or instructions can further include selecting the nearest EVR unit through the client device and/or the rescue service (or services) and accepting the request prior to instructing the nearest EVR unit to drive to the location of the customer/user.

In an embodiment, the EVR unit can be implemented as a system for electric vehicle rescue, the system comprising: a mobile platform including a winch and a ramp, the mobile platform deployable for retrieving an electric vehicle thereon with the winch and the ramp for transportation of the electric vehicle. The system for electric vehicle rescue can (i.e., the EVR unit) can further include a charging unit associated with the mobile platform for connection to the electric vehicle and for recharging of the electric vehicle. The system for electric vehicle rescue can (i.e., the EVR unit) can also include a data processing apparatus for analyzing and testing a functionality of systems and components of the electric vehicle, wherein the data processing apparatus communicates electronically with the charging unit and the electric vehicle and generates an electronic report indicative of a result the analyzing and testing.

In an embodiment, the step, operation or instruction of connecting the user of the client device to the remote server to request the vehicle rescue service (or services), can further include a step, operation or instruction for connecting the user of the client device to the remote server through the client device in communication with a data network to request the vehicle rescue service. Such a data network is preferably a bidirectional packet-based data communications network.

In an embodiment, a system for providing an electric vehicle rescue vehicle, can be implemented, which includes one or more processors; and a non-transitory computer-usable medium embodying computer program code, the computer-usable medium capable of communicating with the processor(s), the computer program code comprising instructions executable by the processor(s) and configured for: connecting a user of a client device to a remote server to request one or more vehicle rescue services; and determining a location of the client device of the user and a location of a nearest EVR (Electric Vehicle Rescue) unit of the vehicle rescue service(s) with respect to the location of the client device, in response to the request of the vehicle rescue service(s).

In an embodiment, a system for electric car rescue, can include: a rescue vehicle that includes a mobile platform comprising a winch and a ramp, the mobile platform deployable for retrieving a disabled electric vehicle thereon with the winch and the ramp for transportation of the disabled electric vehicle; and a charging unit associated with the mobile platform, wherein the charging unit connects to the disabled electric vehicle for recharging of the disabled electric vehicle during a transportation of the disabled electric vehicle on the mobile platform, wherein the rescue vehicle comprises at least one of an autonomous vehicle, a semi-autonomous vehicle, or a non-autonomous vehicle.

In an embodiment, the rescue vehicle can be adapted to carry passengers associated with the disabled electric vehicle as the disabled electric vehicle is being charged by the charging unit during the transportation of the disabled electric vehicle on the mobile platform.

In an embodiment, the rescue vehicle can comprise an electric vehicle.

In an embodiment, the rescue vehicle can comprise a truck.

In an embodiment, the rescue vehicle can comprise an aircraft.

In an embodiment, the aircraft may be a vertical take-off aircraft.

An embodiment can further include a systems analysis module for testing of a functionality of systems and components of the disabled electric vehicle, wherein the systems analysis module connects to and electrically communicates with the disabled electric vehicle.

In an embodiment, the systems analysis module renders an electronic report (e.g., rendered through email, text, social media messaging, etc.) indicative of a result of the testing of the functionality of systems and components of the disabled electric vehicle.

In an embodiment, the systems analysis module can communicate wirelessly with a remote server through a data network to transmit data and results of the testing of the functionality of systems and components of the disabled electric vehicle.

In an embodiment, a system for electric car rescue, can include: a rescue vehicle that includes a mobile platform, the mobile platform deployable for retrieving a disabled electric vehicle thereon for transportation of the disabled electric vehicle; and a charging unit associated with the mobile platform, wherein the charging unit connects to the disabled electric vehicle for recharging of the disabled electric vehicle during a transportation of the disabled electric vehicle on the mobile platform, wherein the rescue vehicle comprises at least one of an autonomous vehicle, a semi-autonomous vehicle, or a non-autonomous vehicle.

In an embodiment, a method of operating a system for electric car rescue, can involve: deploying a mobile platform for retrieving a disabled electric vehicle thereon with a winch and a ramp for transportation of the disabled electric vehicle, the rescue vehicle include the mobile platform comprising the winch and the ramp; and recharging the disabled electric vehicle with a charging unit associated with the mobile platform during a transportation of the disabled electric vehicle on the mobile platform, wherein the rescue vehicle comprises at least one of an autonomous vehicle, a semi-autonomous vehicle, or a non-autonomous vehicle.

### BRIEF DESCRIPTION OF THE DRAWINGS

The accompanying figures, in which like reference numerals refer to identical or functionally similar elements throughout the separate views and which are incorporated in and form a part of the specification, further illustrate the example embodiments and, together with the detailed description of the invention, serve to explain the principles of the disclosed embodiments.

FIG. 1 illustrates a schematic diagram of an electric vehicle rescue system, which can be implemented in accordance with an example embodiment;

FIG. 2 illustrates a flow chart of operations depicting logical operational steps of a method of securing a rescue service by a customer, in accordance with an example embodiment;

FIG. 3 illustrates a flow chart of operations depicting logical operational steps of a method for implementing an electric vehicle rescue, in accordance with an example embodiment;

FIG. 4 illustrates a schematic diagram depicting an example of a mobile computing device that may be implemented in accordance with an example embodiment;

FIG. 5 illustrates a schematic view of a data processing system/apparatus, in accordance with an example embodiment;

FIG. 6 illustrates a schematic view of a software system including a module, an operating system, and a user interface, in accordance with an example embodiment;

FIG. 7 illustrates a schematic diagram of a rescue vehicle system in which the rescue vehicle and/or the rescued vehicle may be autonomous vehicles and/or connected vehicles, in accordance with an embodiment;

FIG. 8 illustrates a schematic diagram of a rescue vehicle system, in accordance with an embodiment; and

FIG. 9 illustrates a pictorial diagram of the electric vehicle rescue system, in accordance with an embodiment.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with the terms “instruction” or “operation”.

The term “data” as utilized herein can relate to physical signals that can indicate or include information. The term “data” can also relate to individual facts, statistics, or items of information, often numeric. In a more technical sense, data can be a set of values of qualitative or quantitative variables about one or more persons or objects, while a datum is a single value of a single variable. The term ‘data’ may also relate to the quantities, characters, and/or symbols on which operations can be performed by a computer, processor and/or application, with the data being stored and transmitted in the form of electrical signals and recorded on magnetic, optical, or mechanical recording media.

The terms “electric vehicle” and “EV” as utilized herein may be used interchangeably and can refer to an all-electric vehicle. Furthermore, terms “battery”, “cell”, and “battery cell” may be used interchangeably and refer to any of a variety of different rechargeable cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration.

The term “battery pack” as used herein can refer to multiple individual batteries that can be contained within a single piece or multi-piece housing, the individual batteries electrically interconnected to achieve the desired voltage and current capacity for a particular application. The terms “energy storage system” and “ESS” may be used interchangeably and refer to an electrical energy storage system that has the capability to be charged and discharged such as a battery, battery pack, capacitor or supercapacitor. In addition, identical element symbols used on multiple figures may refer to the same component, or components of equal functionality.

The present inventors believe there is need for a mobile electric vehicle rescue system than can tow a disabled electric vehicle (EV) and charge it during transport to its destination. The present inventors also believe that analysis of the electric (or “electrical”) vehicle during transport can provide valuable information and service to customers requiring rescue. Retrieval, transport, charging, and analysis are features that can be offered to disabled vehicles as part of a roadside assistance program.

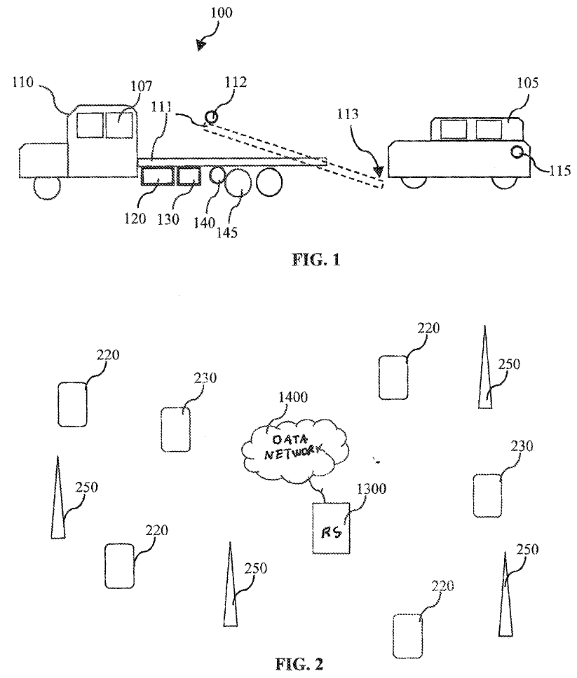

Referring to FIG. 1, an electric vehicle rescue system 100 is illustrated, which can be used to tow a disabled EV (Electric Vehicle) 105 and charge the disabled EV 105 during transport of the disabled EV 105 to a destination, in accordance with an embodiment. By the time the disabled EV 105 arrives at the destination, the disabled EV 105 will no longer be disabled. That is, it will likely have a fully recharged battery.

The EV rescue system 100 can include a rescue vehicle 110 that can include a mobile platform 111 that can comprise, in some embodiments, a winch 112 and a ramp feature 113. The mobile platform 111 can operate as a ramp by mechanized tilting of the mobile platform 111 toward the ground in front of a disabled vehicle as shown by dashed lines in FIG. 1, or a separate ramp section (not shown) can be deployed from the platform. Note that the term ‘rescue vehicle’ as utilized herein refers to the vehicle (e.g., such as a tow truck) that is used to ‘rescue’ the disabled electric vehicle 105. Thus, the disabled electric vehicle 105 is the vehicle that is being rescued (also referred to as the ‘rescued vehicle’).

In some embodiments, the entire platform can be manipulated away from the rear of a truck as a rescue vehicle 110 to place the mobile platform 111 in front of a disabled vehicle 105 that requires towing or transportation. In some embodiments, the mobile platform 111 of the rescue vehicle 110 can be deployed into an angled position in contact with the ground (or close to the ground) for retrieving the disabled EV 105 (the “rescued vehicle”) thereon by operation of a winch 112, which can be connected to a tow hook, or the like, located near the front of a disabled EV 105 as the disabled EV 105 is mechanically pulled onto the mobile platform 111 by the winch 112. Once the disabled EV 105 is in place on the mobile platform 111, it can be secured with straps or chains for transportation.

A charging unit 120 can be included in association with the electric vehicle rescue system 100 for connection to and charging of a battery associated with the disabled EV 105 by connection to a connection port 115 of the EV 105. The EV 105 can include one or more batteries as part of an ESS of the EV 105. That is, the EV 105 includes an ESS that can include the aforementioned battery (or batteries), which can be recharged by the charging unit 102. Charging of the EV 105 can occur either on location or during transport of the EV on the mobile platform 111. A customer (e.g., the user of the EV 105) may be charged separately for charging and transportation, depending on the elected service.

A systems analysis module 130 can also be included in association with the electric vehicle rescue system 100 for testing of the functionality of systems and components of the EV 105, either on site or during transport of the EV 105 on the mobile platform 111. The system analysis module can be connected to a test port (not shown) that may be provided in a compartment within the EV 105. Results of analysis can be provided to customers in printed form or electronically via a data network. The customer may also be charged separately for the analysis.

Results of the analysis by the system analysis module 130 can be provided as data to customers in, for example, a printed form or electronically (e.g., email, a text message, social media messaging, etc.) via a data network. For example, these results can be electronically sent to the customer (e.g., the driver or owner of the disabled EV 105) or another person or entity/service (e.g., a roadside assistance service) in an email, text message or another form of electronic notification (e.g., social media messaging). The customer may be charged separately for this analysis. Note that the term ‘customer’ as utilized herein can relate to the driver/owner of the disabled EV 105 and/or a user of a mobile ‘app’ associated with an entity such as, for example, the aforementioned roadside assistance service. In the case of this mobile app, the customer can request assistance from the roadside assistance service through the mobile app.

The mobile platform 111 can be provided with the rescue vehicle 110 in the form of a trailer pulled by another vehicle (e.g., pulled by a heavy duty truck) or integrated with another vehicle (e.g., the truck 110 as shown). That is, in an embodiment, the rescue vehicle 110 may be a truck or similar vehicle, and the mobile platform 111 can be located on a trailer pulled (e.g., flatbed trailer) pulled by the rescue vehicle 110. In an alternative embodiment, the rescue vehicle 110 and the mobile platform 111 may be incorporate into the same vehicle. For example, as shown in FIG. 1, the mobile platform 111 is integrated into or with the rescue vehicle 110, and the disabled electric vehicle 105 would then be carried on the mobile platform 111 as discussed herein. Note that the term ‘rescue vehicle’ as utilized herein can refer to the vehicle that is used to rescue a disabled vehicle such as the disabled EV 105. As discussed, the term ‘rescued vehicle’ can refer or relate to the vehicle (e.g., disabled EV 105) that is being rescued by the rescue vehicle 110. For example, the disabled EV 105 in this situation is the rescued vehicle (not the rescue vehicle, which is the rescue vehicle 110).

In some embodiments, the electric vehicle rescue system 100 can include the ability to carry passengers from with the disabled EV 105 as the disabled EV 105 is being transported, charged, and/or analyzed by the rescue vehicle. For example, the mobile platform 111 can be integrated or installed onto the back of a heavy duty, four door truck 107 (e.g., crew cab) that can also function as a shuttle for transporting the paying passengers (i.e., the passenger and/or driver of the disabled EV 105).

It is also a feature of the disclosed embodiments that the rescue vehicle can include means for charging batteries associated with the rescue vehicle or the rescued vehicle. Such means for charging can include but is not limited to at least one PV panel associated with the mobile platform 111 to charge batteries when a vehicle is not being transported. A generator 140 can also be associated with one or more of the wheels 145 (or axles) of the rescue vehicle and can generate power as the rescue vehicle is moving on a road or highway while transporting a rescued electric vehicle. This power can be utilized for charging the rescued electric vehicle. The time that it takes to charge an EV can be dependent on the amount of amperage and power that can be provided by the charging system. There may be, for example, Level 1, Level 2, and DC charging stations available at stationary locations.

The DC charging stations, such as, for example, the 480 volt DC CHAdeMO fast charging stations, are the highest power systems available today, are a three-phase system, and can charge an EV as soon as, for example, 20-30 minutes; however, significant power must be generated to accomplish fast charge. On the mobile platform 111, a fast charge may also be accomplished if additional means for generating power are provided. For example, a bank of batteries may be available on or in association with the mobile platform 111 to transfer DC charging energy to the EV batteries of the ESS of the EV 105. Variations of solar panels, generators, and other batteries may provide enhanced charging capabilities for the rescue vehicle.

The charging unit 120 can thus implement a fast charge with respect to the disabled EV 105 located on the mobile platform 111. The term ‘fast charge’ as utilized herein relates to fast charging of electric batteries associated with electric vehicles. The charging unit 120 can be modified to deliver a fast charge such as disclosed in U.S. Patent Application Publication No. 20210268931entitled “System, Apparatus and Methods of Electricity Generation to End-Use for Fast Charging of Electric Vehicle,” which was published on Sep. 2, 2021, and is incorporated herein by reference in its entirety. some embodiments, the charging unit 120 may include an EV

Retrieval, transport, charging, and analysis are features that can be offered to disabled vehicles as part of a roadside assistance program. Referring to FIG. 2, it is also a feature of the disclosed embodiments that a roadside assistance service includes an electric vehicle rescue system 100 as described herein that can be provided via a network of independent providers 230 that can be connected to stranded EV customers 220 using a mobile application accessed by providers and customers alike, and the provider and customer matching and transaction are managed by an RS (Remote Server) 1300 via a data network 1400 and matching can be based on physical location (e.g., GPS, or triangulation based on cellular network towers 250) of the independent providers and the stranded customer making a request. Note that the data network 1400 can be, for example, a bidirectional packet-based data communications network.

The data network 1400 can couple devices so that communications may be exchanged, such as between a remote server (RS) 1300 and client devices or other types of devices, including between wireless devices coupled via a wired or a wireless network, for example. The data network 1400 can in some example embodiments include mass storage, such as network-attached storage (NAS), a storage area network (SAN), or other forms of computer or machine-readable media, for example. The data network 1400 may include the Internet, one or more local area networks (LANs), one or more wide area networks (WANs), wire-line type connections, wireless type connections, cellular communications networks, or any combination thereof. Likewise, sub-networks may employ differing architectures or may be compliant or compatible with differing protocols and may interoperate within a larger network. Various types of devices may, for example, be made available to provide an interoperable capability for differing architectures or protocols. As one illustrative example, a router may provide a link between otherwise separate and independent LANs.

The data network 1400 may communicate with client devices, network towers 250 and so on via a communications link or channel which may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless communications links including satellite links, cellular communications links, or other communication links or channels. Furthermore, a computing device or other related electronic devices may be remotely coupled to a network, such as via a telephone line or link, for example. Customers 220, for example, may use client devices such as the client device 22 shown in FIG. 4 to communicate with the data network 1400. That is, a customer may use a client device such as a tablet-computing device, a smartphone to communicate with the remote server 1300 through the data network 1400.

The communications link or channel may include wireless communications means. That is, the data network 1400 can be configured as a wireless network that can couple client devices with the data network 1400 via wireless communications means. The data network 1400 may employ stand-alone ad-hoc networks, mesh networks, wireless LAN (WLAN) networks, cellular networks, or the like. The data network 1400 can be a wireless network that includes a system of terminals, gateways, routers, or the like coupled by wireless radio links, or the like, which may move freely, randomly, or organize themselves arbitrarily, such that network topology may change, at times even rapidly. A wireless network may further employ a plurality of network access technologies including Long Term Evolution (LTE), WLAN, Wireless Router (WR) mesh, or 2nd, 3rd, 4th generation (2G, 3G, 4G, 5G) cellular technology, or the like. Network access technologies can enable wide area coverage for client devices and so on with varying degrees of mobility, for example.

The data network 1400 can be configured as a wireless network that enables RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. The wireless network 1400 may include virtually any type of wireless communication mechanism by which signals may be communicated between devices, such as a client device or a computing device, between or within a network, or the like.

Signal packets communicated via the data network 1400 may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the internet may, for example, be routed via a path of gateways, servers, etc., that may route the signal packet in accordance with a target address and availability of a network path to the target address.

Mobile ‘apps’, such as UBER and LYFT are available on mobile devices to hire transportation from point A to point B for a customer. However, there is not a similar app that can match rescue vehicles with disabled vehicles in need of rescue. The term “app” as utilized herein refers to an application or software application such as a software program. An ‘app’ can refer to software or software programs used on a mobile computing device such as a smartphone, a tablet computing device, a wearable computing device, and so on. In other embodiments, an ‘app’ may refer to a “web app” or “online app” such as software that a user can access and use while online, via for example, a browser, instead of residing on a client device.

Thus, in some embodiments an “app” may be a software application that can be resident on and/or run on a mobile computing device, while and in other embodiments the mobile app may be accessed and used online via a client device such as a mobile computing device, a laptop computer, a computer server, a desktop computer and so on. An example of the client device is the client device 22 shown in FIG. 4.

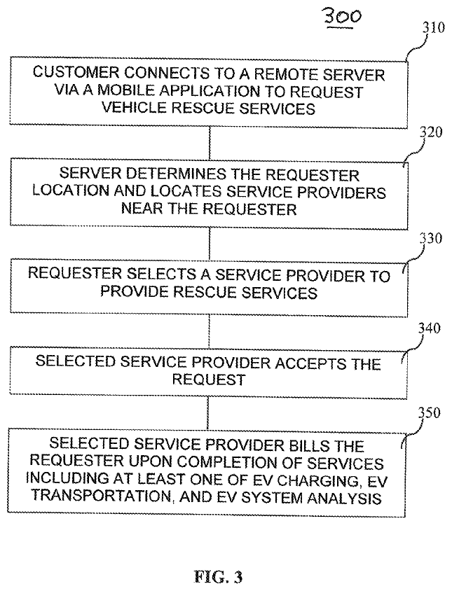

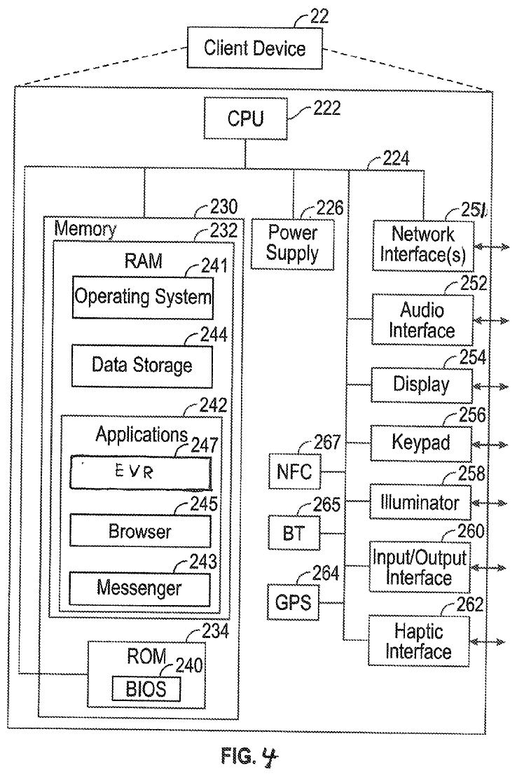

FIG. 3 illustrates a flow chart of operations depicting logical operational steps of a method 300 for implementing an electric vehicle rescue, in accordance with an example embodiment. As indicated at block 310, a customer/user can connect to a remote server via a mobile application or “app” to request vehicle rescue services (e.g., roadside assistance). A non-limiting example of a roadside assistance service and a mobile app for requesting assistance, which may be adapted in an embodiment as a rescue service for the disabled EV 105, is disclosed, for example, in U.S. Patent Publication No. 20210314753 entitled “Systems and Methods for Automatic Breakdown Detection and Roadside Assistance,” which published on Oct. 7, 2021 and is incorporated herein by reference in its entirety.

As shown next at block 320, the server can determine the requester's location and locate service providers near the requester. This determination of the requester's location may be based on geographical location (e.g., GPS signal) associated with the requester's mobile device. As depicted next at block 330, the requester can select a service provider to provide rescue services for the disabled EV 105. This selection can be made through, for example, the aforementioned mobile app.

As indicated next at block 340, the selected service provider can accept the request. Then, as described at block 350, the service provider can bill the requester (e.g., the user or customer) upon completion of services including one or more of EV charging, EV transportation, and EV analysis.

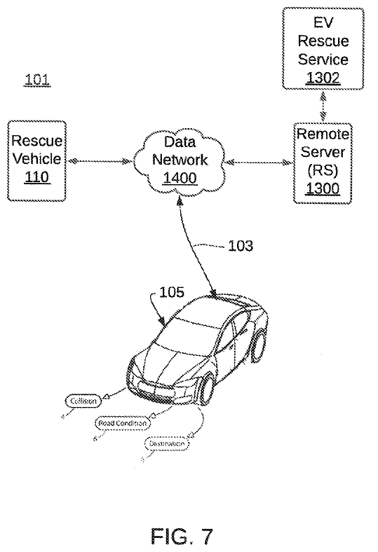

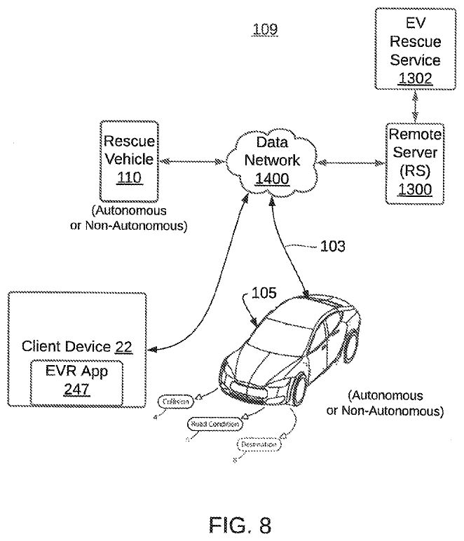

FIG. 4 illustrates a schematic diagram depicting an example of a mobile computing device 22 (e.g., a client device) that can be implemented in accordance with an example embodiment. It should be appreciated that the mobile computing device 22 (also referred to as a client device or simply a mobile device) shown in FIG. 4 is exemplary only and that many variations to this device 22 are possible. The mobile computing device or client device 22 shown in FIG. 4 can function as a computing device capable of sending or receiving signals through a wired or a wireless network such as, for example, the data network 1400 shown in FIG. 2. Note that the data network 1400 is also depicted in FIG. 7 and FIG. 8 herein, in accordance with alternative embodiments

The client device 22 may be, for example, a desktop computer or a portable device, such as a cellular telephone, a smartphone, a display pager, a radio frequency (RF) device, an infrared (IR) device, a Personal Digital Assistant (PDA), a handheld computer, a tablet computer, a laptop computer, a wearable computer, or an integrated device combining various features, such as features of the foregoing devices, or the like. In a preferred example embodiment, however, it can be assumed that the client device 22 is a mobile device such as, for example, a smartphone, tablet computing device, a smartwatch, or other wearable computing devices.

The client device 22 may vary in terms of capabilities or features. The claimed subject matter is intended to cover a wide range of potential variations. For example, a cell phone is a client device that may include a numeric keypad or a display of limited functionality, such as a monochrome liquid crystal display (LCD) for rendering text and other media. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example. The client device 22 may be a mobile device such as, for example, an iPhone™, an iPad, an Android Phone, a laptop computer, and so on.

The client device 22 can include or can execute a variety of operating systems, such as operating system 241, including in some example embodiments, a personal computer operating system, such as a Windows®, iOS® or Linux®, or a mobile operating system, such as iOS®, Android®, or Windows Mobile®, or the like. Thus, in some example embodiments, the client device 22 may be a smartphone such as an iPhone® or an Android®-based smartphone or other types of smartphones. In another embodiment, the client device 22 may be a tablet-computing device such as an iPad, a Galaxy tablet, and so on. In still other embodiments, the client device 22 may be a wearable computing device such as a smartwatch, or simply a portable computing device such as a laptop computer.

The client device 22 may include or may execute a variety of possible applications, such as a client software application enabling communication with other devices, such as communicating one or more messages, such as via email, short message service (SMS), or multimedia message service (MMS), including via a network, such as an online social network, including, for example, Facebook®, LinkedIn®, Twitter®, Flickr®, Instagram®, TikTok®, and so on.

The client device 22, may also include or execute an application to communicate content, such as, for example, textual content, multimedia content, or the like. A client device may also include or execute an application to perform a variety of possible tasks, such as browsing, searching, playing various forms of content, including locally stored or streamed video, or games (e.g., fantasy sports leagues, etc.). The foregoing is provided to illustrate that claimed subject matter is intended to include a wide range of possible features or capabilities. Examples of such applications or “apps” (or modules) can include a messenger app 243, a browser app 245, and other client application(s) or module(s) such as an EVR (Electric Vehicle Rescue) app 247 that can facilitate interactivity and communications between the client device 22 and a remote server such as the remote server 1300 shown in FIG. 2. The EVR app 247 can, for example, provide instructions, steps or operations such as those shown and described herein with respect to blocks 310, 320, 330, 340, 350 of FIG. 3.

The client device 22 can include a CPU (Central Processing Unit) 222 and/or other processors (not shown) coupled electronically via a system bus 224 to memory 230, power supply 226, and a network interface 251. The memory 230 can be composed of RAM (Random Access Memory) 232 and ROM (Read Only Memory) 234. Other example components that may be included with client device 22 can include, for example, an audio interface 252, a display 254, a keypad 256, an illuminator 258, and an input/output interface 260. In some embodiments, a haptic interface 262 and a GPS (Global Positioning System) module or unit 264 along with a Bluetooth (BT) module 265 and an NFC (Near Field Communications) module 267 can also be electronically coupled via the system bus 224 to CPU 222, memory 230, power supply 226, and so on.

The BT (Bluetooth) module 265 can permit communication of client device 22 with other devices, including Bluetooth and/or BLE beacons and/or transponders as discussed herein. For example, the rescue vehicle 110 may be equipped with Bluetooth communications components and/or BLE beacons and/or transponders that may communicate with client device through Bluetooth, BLE communications and so on. The near field communication (NFC) module 267 can facilitate NFC communication with other devices including, e.g., an NFC beacon. With respect to the Bluetooth module 265, it may be implemented as a Bluetooth Low Energy (BLE) module and/or a Bluetooth 4.0 module that implements communications using one or more of BLE systems, standard Bluetooth systems, and/or iBeacon systems specifically. As understood herein, BLE may operate in the same spectrum range (e.g., the 2.400 GHz-2.4835 GHz band) as classic Bluetooth technology but may use a different set of channels. Instead of Bluetooth's seventy-nine 1-MHz channels, e.g., BLE can employ forty 2-MHz channels. BLE may send data within a channel using Gaussian frequency shift modulation with a one megabyte per second data rate and a maximum transmission power of ten milliwatts (10 mW).

RAM 232 can store an operating system 241, provide for data storage 244, and the storage of applications 242 such as, for example, browser 245 and messenger 243 applications. ROM 234 can include a BIOS (Basic Input/Output System) 240, which is a program that the CPU 222 utilizes to initiate the computing system associated with client device 22. BIOS 240 can also manage data flow between operating system 241 and components such as display 254, keypad 256, and so on.

Applications 242 can thus be stored in memory 230 and may be “loaded” (i.e., transferred from, for example, memory 230 or another memory location) for execution by the client device 22. Client device 22 can receive user commands and data through, for example, the input/output interface 260. The client device 22 in accordance with instructions from operating system 241 and/or application(s) 242 may then act upon such inputs. The interface 260, in some embodiments, can serve to display results, whereupon a user may supply additional inputs or terminate a session. The software application(s) 242 can include one or more modules such as modules 243, 245, 247, and so on, which can, for example, implement instructions or operations such as those described herein.

The client device 22 can communicate through, for example, a data communications network such as the data network 1400 and the aforementioned remote server 1300. In some example embodiments, the data network 1400 may be implemented as a wireless network, which may, for example, employ stand-alone ad-hoc networks, mesh networks, wireless LAN (WLAN) networks, cellular networks, or the like. Such a wireless network can include a system of terminals, gateways, routers, or the like coupled by wireless radio links, or the like, which may move freely, randomly or organize themselves arbitrarily, such that network topology may change, at times even rapidly. Such a wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a data network such as data network 1400 may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Long-Term Evolution Time-Division Duplex (LTE-TDD), LTE-FDD, LTE Direct, 4G, Wideband Code Division Multiple Access (WCDMA), Bluetooth, 802.11b/g/n, or the like. The data network 1400 may include virtually any type of wireless communication mechanism by which signals may be communicated between devices, such as a client device or a computing device, between or within a network, or the like.

Signal packets communicated via the data network 1400, such as a network of participating digital communication networks may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

Note that the Internet refers to a decentralized global network of networks. The Internet includes Local Area Networks (LANs), Wide Area Networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

As can be appreciated by one skilled in the art, embodiments can be implemented in the context of a method, data processing system, or computer program product. Accordingly, example embodiments may take the form of an entirely hardware embodiment, an entirely software embodiment or an embodiment combining software and hardware aspects all generally referred to herein as a “circuit” or “module.” Furthermore, embodiments may in some cases take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, server storage, databases, etc.

Computer program code for carrying out operations of the present invention may be written in an object-oriented programming language (e.g., Java, C++, etc.). The computer program code, however, for carrying out operations of particular embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (for example, through the Internet utilizing an Internet Service Provider).

The example embodiments are described at least in part herein with reference to flowchart illustrations and/or block diagrams of methods, systems, and computer program products and data structures. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks. To be clear, the disclosed embodiments can be implemented in the context of, for example a special-purpose computer or a general-purpose computer, or other programmable data processing apparatus or system. For example, in some embodiments, a data processing apparatus or system can be implemented as a combination of a special-purpose computer and a general-purpose computer.

These computer program instructions may also be stored in a computer-readable memory that can direct a computer or other programmable data processing apparatus to function in a particular manner, such that the instructions (e.g., steps, operations or functions) stored in the computer-readable memory produce an article of manufacture including instruction means which implement the function/act specified in the various block or blocks, flowcharts, and other architecture illustrated and described herein.

Note that a processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general-purpose processor, a digital signal processor (DSP), an integrated circuit, a server, other programmable logic device, or any combination thereof. A processor may be a conventional processor, microprocessor, controller, microcontroller, or a state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flowchart and block diagrams in the figures illustrate the architecture, functionality, and operation of possible implementations of systems, methods, and computer program products according to various example embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

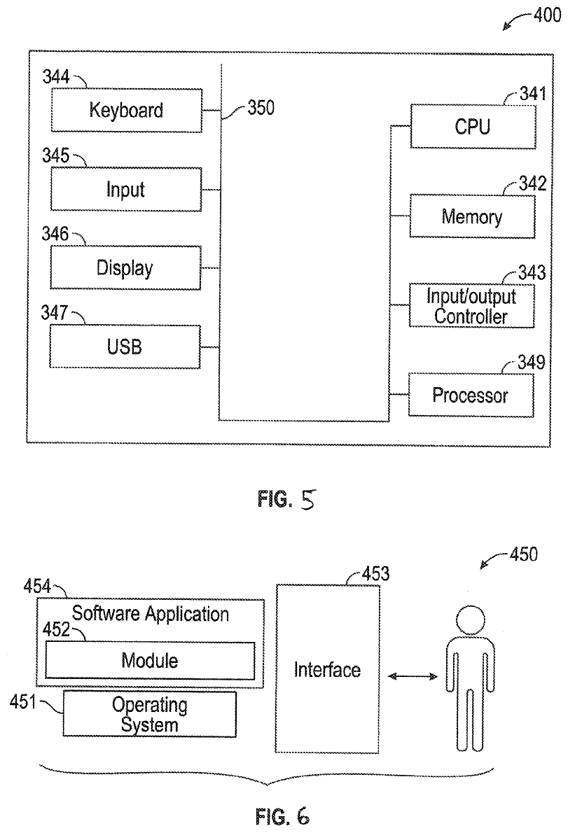

FIGS. 5-6 are shown only as exemplary diagrams of data-processing environments in which example embodiments may be implemented. It should be appreciated that FIGS. 5-6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 5, some embodiments may be implemented in the context of a data-processing system/apparatus 400 that can include, for example, one or more processors such as a processor 341 (e.g., a CPU (Central Processing Unit) and/or other microprocessors), a memory 342, an input/output controller 343, a processor 349 (e.g., microprocessor, controller, microcontroller, state machine, etc.), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.) and/or other peripheral connections and components.

As illustrated, the various components of data-processing system/apparatus 400 can communicate electronically through a system bus 350 or similar architecture. The system bus 350 may be, for example, a subsystem that transfers data between, for example, computer components within data-processing system/apparatus 400 or to and from other data-processing devices, components, computers, etc. The data-processing system/apparatus 400 may be implemented in some embodiments as, for example, a server in a client-server based network (e.g., the Internet) or in the context of a client and a server (i.e., where aspects are practiced on the client and the server).

In some example embodiments, data-processing system/apparatus 400 may be, for example, a standalone desktop computer, a laptop computer, a smartphone, a pad computing device and so on, wherein each such device is operably connected to and/or in communication with a client-server based network and/or other types of networks (e.g., cellular networks, Wi-Fi, etc.).

FIG. 6 illustrates a computer software system/apparatus 450 for directing the operation of the data-processing system/apparatus 400 depicted in FIG. 5, in accordance with an example embodiment. The software application 454 can include a module 452 (i.e., note the module 452 may be stored in, for example, the memory 342 shown in FIG. 5). The computer software system/apparatus 450 also generally includes a kernel or operating system 451 and a shell or interface 453. One or more application programs, such as software application 454, may be “loaded” (i.e., transferred from, for example, mass storage or another memory location into the memory 342) for execution by the data-processing system/apparatus 400. The data-processing system/apparatus 400 can receive user commands and data through the interface 453; these inputs may then be acted upon by the data-processing system/apparatus 400 in accordance with instructions from operating system 451 and/or software application 454. The interface 453 in some embodiments can serve to display results, whereupon a user (e.g., shown in FIG. 15 to right of the interface 453) may supply additional inputs or terminate a session. The software application 454 can include the module(s) 452, which can, for example, implement the various instructions or operations such as those discussed herein. Module 452 may also be composed of a group of modules or sub-modules that implement particular modules, such as, for example, the various modules 242 discussed previously.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

The term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which is typically private (accessible only to that module), and which includes source code that actually implements the routines in the module. The term module as utilized herein may also simply refer to an application, such as a computer program designed to assist in the performance of a specific task, such as word processing, accounting, inventory management, etc. In other embodiments, a module may be a hardware component or a combination of hardware and software.

FIG. 5 and FIG. 6 are intended as examples and not as architectural limitations of the disclosed embodiments. Additionally, such example embodiments are not limited to any particular application or computing or data processing environment. Instead, those skilled in the art can appreciate that the disclosed approach may be advantageously applied to a variety of systems and application software. Moreover, the disclosed embodiments can be embodied on a variety of different computing platforms, such as but not limited to Mac OS (Operation System), Windows, Android, UNIX, LINUX, and so on.

As utilized herein, the term “vehicle” can be defined as a conveyance that provides transport to humans, animals, machines, cargo, or other objects. An “occupant” is defined as a person, animal, or machine that is transported or transportable by a vehicle. In view of this definition, a person, animal, or machine may be considered an occupant when inside the vehicle or outside the vehicle. Thus, an occupant may be, for example, a vehicle driver or a vehicle passenger.

The term ‘vehicle’ as utilized herein can in some embodiments relate to an autonomous vehicle. That is, in some embodiments, the rescue vehicle 110 may be an autonomous vehicle and/or the disabled EV 105 may be an autonomous vehicle. The term ‘autonomous vehicle’ as utilized herein can relate to a vehicle (e.g., an electric vehicle, a motorized vehicle, etc.) that can navigate without a human driver. An autonomous vehicle can include a plurality of sensor systems, such as, but not limited to, a camera sensor system, a lidar sensor system, a radar sensor system, amongst others, wherein the autonomous vehicle can operate based upon sensor signals output by the sensor systems. Specifically, the sensor signals can be provided to an internal computing system in communication with the plurality of sensor systems, wherein a processor can execute instructions based upon the sensor signals to control a mechanical system (e.g., vehicle propulsion system, a braking system, a steering system) and/or an electrical system of the autonomous vehicle.

The term ‘vehicle’ as utilized herein can also relate to a so-called connected vehicle (which may or may not be an autonomous vehicle). The term “connected vehicle” can relate to a vehicle that can be equipped with Internet access, and usually also with a wireless local area network. This can allow the vehicle to share Internet access with other devices both inside as well as external to the vehicle. The connected vehicle can be outfitted with special technologies that tap into the Internet or a wireless LAN and provides additional benefits to the occupant. For safety-critical applications, a connected vehicle can be connected using Dedicated Short Range Communication (DSRC) radios, operating in the FCC-granted 5.9 GHz band with very low latency.

As noted above, a connected vehicle may or may not be an autonomous vehicle. An “autonomous vehicle” can be a vehicle configured to sense its environment and navigate itself with or without human interaction. An autonomous vehicle may operate in one or more modes, including a fully autonomous mode, a semi-autonomous (for example, adaptive cruise control) mode, or in a manual mode (e.g., the human operator/driver has control of the vehicle). A vehicle that is semi-autonomous may include a mode in which the vehicle may operate as a vehicle driven by a driver and in other situations the same vehicle may function as a completely autonomous vehicle.

In some example embodiments, the disabled EV (Electric Vehicle) 105 may be vehicle that is driven by a human operator (e.g., a vehicle driver) or may be a vehicle such as a connected vehicle and/or an autonomous vehicle. The rescue vehicle 110 of the EV rescue system 100 may similarly in some example embodiments be a vehicle such as a connected vehicle and/or an autonomous vehicle. A non-limiting example of an autonomous vehicle and related systems and methods, which may be adapted for use as, for example, the vehicle 105 and/or the vehicle 110 is disclosed in U.S. Patent Application Publication No. 20170320501, entitled “Systems and Methodologies for Controlling an Autonomous Vehicle,” which published on Nov. 9, 2017 and which is incorporated herein by reference in its entirety.

FIG. 7 illustrates a schematic diagram of a rescue vehicle system 101 in which the rescue vehicle 110 and/or the rescued vehicle 105 may be autonomous vehicles and/or connected vehicles, in accordance with an embodiment. In the embodiment shown in FIG. 7, the EV vehicle 105 can detect a collision 4, a road condition 6, a destination 8, and other items/conditions. The vehicle 105 can communicate with the remove server 1300 through the data network 1400 via wireless communications as discussed previously herein. An example of an autonomous or self-driving vehicle, which may be adapted for use as, for example, the vehicle 105 and/or the vehicle 110 shown in FIG. 7, is disclosed in U.S. Patent Application Publication No. 20170300053, which published on October 19, 2017 and is incorporated herein by reference in its entirety.

In some embodiments, when the electric vehicle 105 becomes disabled, a rescue signal can be transmitted via wireless communications 103 to the bidirectional wireless packet-based data network 1400 to the remote server 1300, which can be associated with and/or communicates with an electric vehicle rescue service 1302. The rescue signal may include, for example, GPS coordinates and/or other geolocation information of the electric vehicle 105.

The rescue vehicle 110, which in this scenario may also be an autonomous vehicle with a passenger or passengers, can be dispatched to the location of the disabled vehicle 105 for rescue/transportation, and analysis and charging of the disabled vehicle 105, as discussed previously. It can be assumed that the rescue vehicle 110 can be configured to automatically attach and tow the disabled vehicle 105 as discussed previously herein, or the rescue vehicle may be a semi-autonomous vehicle with a human occupant to assist in the

Page 32 of 42

PATENT APPLICATION 1000-3419 CIP1

Continuation-in-Part process of towing and charging the disabled vehicle 105 as discussed previously herein.

[000107] The term “vehicle” as utilized herein can refer not only to automobiles such as cars and trucks, but can also refer to aircraft, such as airplanes, helicopters and other types of aircraft, such as mini aircraft, air taxis, personal airplanes and so-called “flying cars”. Such vehicles may be piloted by a human or may be semi-autonomous or completely autonomous vehicles. One example of an aircraft that can be adapted for use as a ‘vehicle’ is disclosed in non-limiting U.S. Patent Application Serial No. US20160023754 Al entitled “Vertical take- off aircraft” which was published on January 28, 2016 and is incorporated herein by reference in its entirety. Another non-limiting example of a personal aircraft that can be adapted for use as a ‘vehicle’ is disclosed in non-limiting U.S. Patent Application Serial No. US20130214086, which published on August 22, 2013 and is incorporated herein by reference in its entirety.

[000108] Yet another example of an aircraft that can be adapted for use as a ‘vehicle’ is the TriFan 600 aircraft manufactured by XTI Aircraft, which is an aircraft that uses three ducted fans. Other non-limiting example of various types of aircraft that can be adapted for use in accordance with various example embodiments are disclosed in the paper “Fast Forwarding to a Future of On-Demand Urban Air Transportation,” Uber Elevate, dated October 27, 2016, which is incorporated herein by reference in its entirety. An autonomous vehicle may also be an unmanned aerial vehicle or system (UAV/UAS), a drone, an unmanned ground vehicle, an unmanned water vehicle, or any other type of autonomous vehicle.

[000109] In some embodiments, the rescue vehicle 110 of the EV rescue system 100 may include an aircraft as discussed above that can fly to the location of the disabled EV 105 and may connect to the disabled EV 105 and lift the disabled EV 105 from the ground into the air and fly the disabled EV 105 to another location and charge the disabled EV 105 “in flight”. By the time the disabled EV 105 is transported by air to the other location, the batteries of the EV 105 may be partially charged or completely charged. In this scenario, the rescue vehicle 110 can be implemented as aircraft which may be configured with a mobile platform that can lift and transport the disabled EV 105 to another location. In some embodiments,

Page 33 of 42

PATENT APPLICATION 1000-3419 CIP1

Continuation-in-Part the rescue vehicle 110 may be an aerial drone that can fly to the location of the disabled EV 105 to retrieve and transport the disabled EV 105 and charge it while in flight.

The electric vehicle rescue service 1302 shown in FIG. 7 may also be in some embodiments, a mobile app such as the EVR app 247 discussed previously, which a user of the EV 105 may use to request a vehicle rescue. That is, the electric vehicle rescue service 1302 can be implemented as an EVR (Electric Vehicle Rescue) app that can facilitate interactivity and communications between a mobile device and a remove server such as RS 1300. When the electric vehicle rescue service 1302 comprises and/or is associated with a mobile app (e.g., see the EVR app 247 in FIG. 4 and FIG. 8), such a mobile app may be used from a mobile device such as, for example, the client device 22.

FIG. 8 illustrates a schematic diagram of a rescue vehicle system 109, in accordance with an alternative embodiment. The rescue vehicle system 109 shown in FIG. 8 is similar to the rescue vehicle system 101 shown in FIG. 7. That is, the rescue vehicle system 109 depicted in FIG. 8 represents a slightly different version of the rescue vehicle system 101 shown in FIG. 7. As depicted in FIG. 8, the client device 22 can include or can be associated with the EVR app 247 to request the services of the electric vehicle rescue service 1302 to dispatch the rescue vehicle 110 to ‘rescue’ the disabled vehicle 105, as discussed previously.

A customer/user, using the client device 22, can connect to the remote server 1300 via the EVR app 247 to request vehicle rescue services from the electric vehicle rescue service 1302. The customer/user may be a driver or passenger of the disabled vehicle 105. In an embodiment, the remote server 1300 can determine the location of the requester (e.g., the customer/user) and can further locate service providers (e.g., rescue vehicle 110) near the requester. The requester can then select a service provider to provide rescue services for the disabled vehicle 105. The selected service provider can accept the request and the rescue vehicle 110 can be dispatched to the location of the requester. Note that in some instances the selected service provider may simply be the electric vehicle rescue service 1302. In other instances, the electric vehicle rescue service 1302 may act as a kind of clearinghouse to refer the requester to a particular selected service provider. The ‘selection’ of the service provider may be made by the electric vehicle rescue service 1302 and/or by the requester through the EVR app 247.

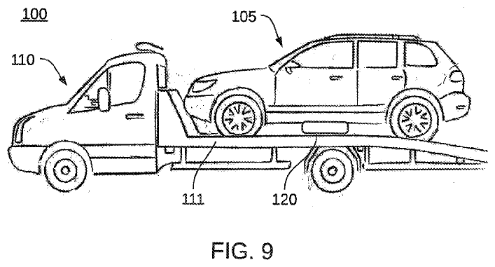

FIG. 9 illustrates a pictorial diagram of the electric vehicle rescue system 100, in accordance with an alternative embodiment. In the example shown in FIG. 9, the charging unit 120 is shown as disposed below the disabled electric vehicle 105 and is charging the disabled electric vehicle 105 from below, or beneath in an area between the mobile platform 111 of the rescue vehicle 110 and the disable electric vehicle 105. The charging unit can provide electromagnetic charging capabilities wherein electromagnetic energy emanates from the charging unit 120 toward a receiving coil installed beneath the disabled electric vehicle 105.

Based on the foregoing, it can be appreciated that a number of different embodiments are disclosed herein, some of which may be preferred embodiments and some of which may be alternative embodiments. In an embodiment, for example, a system for electric vehicle rescue, can include a mobile platform including a winch and a ramp, the mobile platform deployable for retrieving an electric vehicle thereon with the winch and the ramp for transportation of the electric vehicle; a charging unit associated with the mobile platform for connection to the electric vehicle and for recharging of the electric vehicle; a data processing apparatus for analyzing and testing a functionality of systems and components of the electric vehicle, wherein the data processing apparatus communicates electronically with the charging unit and the electric vehicle and generates an electronic report indicative of a result the analyzing and testing. The electric vehicle can comprise one or more an autonomous vehicle or a semi-autonomous vehicle.

In an embodiment, the mobile platform can comprise a trailer pulled by another vehicle, wherein the another vehicle comprises at least one of an autonomous vehicle or a semi-autonomous vehicle.

In an embodiment, the mobile platform may be integrated with the another vehicle.

In an embodiment, a vehicle may be adapted to carry passengers associated with the electric vehicle as the electric vehicle is being charged by the charging unit.

In an embodiment, a remote server may be in communication with a data network and the data network can communicate with the electric vehicle.

In an embodiment, a method for providing an electric vehicle rescue vehicle, can involve: connecting a user of a client device to a remote server to request at least one vehicle rescue service; determining a location of the client device of the user and a location of a nearest EVR (Electric Vehicle Rescue) unit of the at least one vehicle rescue service with respect to the location of the client device, in response to the request of the at least one vehicle rescue service; and instructing the nearest EVR unit to go to the location of the user, wherein the nearest EVR unit comprises at least one of an autonomous vehicle or a semi-autonomous vehicle.

An embodiment of the method can further involve the user selecting the nearest EVR unit through the client device.

An embodiment of the method can further involve an electric vehicle rescue service selecting the nearest EVR unit (e.g., such as the rescue vehicle 110) on behalf of the user and then dispatching the nearest EVR unit to the location of the user.

An embodiment of the method can further involve the vehicle rescue service accepting the request prior to the instructing the nearest EVR unit to drive to the location of the user.

In an embodiment, the EVR unit (e.g., the rescue vehicle 110) can include a mobile platform including a winch and a ramp, and the mobile platform can be deployable for retrieving an electric vehicle (e.g., disabled vehicle 105) thereon with the winch and the ramp for transportation of the electric vehicle and charging of the electric vehicle during its transportation on the mobile platform.

An embodiment can further include a charging unit associated with the mobile platform for connection to the electric vehicle and for recharging of the electric vehicle.

An embodiment can further include a data processing apparatus and/or software for analyzing and testing a functionality of systems and components of the electric vehicle, wherein the data processing apparatus can communicate electronically with the charging unit and the electric vehicle and can generate an electronic report indicative of the result the analyzing and testing.

An embodiment can further involve connecting the user of the client device to the remote server to request the vehicle rescue service.

An embodiment can further involve connecting the user of the client device to the remote server through the client device in communication with the data network to request a dispatch of the rescue vehicle to the location of the user.

In an embodiment, a system for providing electric vehicle rescue can include at least one processor; and a non-transitory computer-usable medium embodying computer program code, the computer-usable medium capable of communicating with the at least one processor. The computer program code can include instructions executable by the at least one processor and configured for: connecting a user of a client device to a remote server to request at least one vehicle rescue service; and determining a location of the client device of the user and a location of a nearest EVR (Electric Vehicle Rescue) unit of the at least one vehicle rescue service with respect to the location of the client device, in response to the request of the at least one vehicle rescue service, wherein the nearest EVR unit comprises at least one of an autonomous vehicle or a semi-autonomous vehicle.

In an embodiment, the instructions can be further configured for directing the nearest EVR unit to drive to the location of the user.

In an embodiment, the instructions can be further configured for permitting the user to select nearest EVR unit through the client device.

In an embodiment, the instructions can be further configuring to allow the at least one vehicle rescue service to accept the request prior to instructing the nearest EVR unit to drive to the location of the user.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A system for electric car rescue, the system comprising:
a rescue vehicle that includes a mobile platform comprising a winch and a ramp, the mobile platform deployable for retrieving a disabled electric vehicle thereon with the winch and the ramp for transportation of the disabled electric vehicle; and
a charging unit associated with the mobile platform, wherein the charging unit connects to the disabled electric vehicle for recharging of the disabled electric vehicle during a transportation of the disabled electric vehicle on the mobile platform, wherein the rescue vehicle comprises at least one of an autonomous vehicle, a semi-autonomous vehicle, or a non-autonomous vehicle.

2. The system of claim 1, wherein the rescue vehicle is adapted to carry passengers associated with the disabled electric vehicle as the disabled electric vehicle is being charged by the charging unit during the transportation of the disabled electric vehicle on the mobile platform.

3. The system of claim 1, wherein the rescue vehicle comprises an electric vehicle.

4. The system of claim 3, wherein the rescue vehicle comprises a truck.

5. The system of claim 1, wherein the rescue vehicle comprises an aircraft.

6. The system of claim 5, wherein the rescue vehicle comprises a vertical take-off aircraft.

7. The system of claim 1, further comprising a systems analysis module for testing of a functionality of systems and components of the disabled electric vehicle, wherein the systems analysis module connects to and electrically communicates with the disabled electric vehicle.

8. The system of claim 7, wherein the systems analysis module renders an electronic report indicative of a result of the testing of the functionality of systems and components of the disabled electric vehicle.

9. The system of claim 7, wherein the systems analysis module communicates wirelessly to a remote server through a data network to transmit data and results of the testing of the functionality of systems and components of the disabled electric vehicle.

10. A system for electric car rescue, the system comprising:
a rescue vehicle that includes a mobile platform, the mobile platform deployable for retrieving a disabled electric vehicle thereon for transportation of the disabled electric vehicle; and
a charging unit associated with the mobile platform, wherein the charging unit connects to the disabled electric vehicle for recharging of the disabled electric vehicle during a transportation of the disabled electric vehicle on the mobile platform, wherein the rescue vehicle comprises at least one of an autonomous vehicle, a semi-autonomous vehicle, or a non-autonomous vehicle.

11. The system of claim 10, wherein the rescue vehicle is adapted to carry passengers associated with the disabled electric vehicle as the disabled electric vehicle is being charged by the charging unit during the transportation of the disabled electric vehicle on the mobile platform.

12. The system of claim 10, wherein the rescue vehicle comprises an electric vehicle.

13. The system of claim 12, wherein the rescue vehicle comprises a truck.

14. The system of claim 10, wherein the rescue vehicle comprises an aircraft.

15. The system of claim 14, wherein the aircraft comprises a vertical take-off aircraft.

16. The system of claim 10, further comprising a systems analysis module for testing of a functionality of systems and components of the disabled electric vehicle, wherein the systems analysis module connects to and electrically communicates with the disabled electric vehicle.

17. The system of claim 16, wherein the systems analysis module renders an electronic report indicative of a result of the testing of the functionality of systems and components of the disabled electric vehicle.

18. A method of operating a system for electric car rescue, the method comprising:
deploying a mobile platform for retrieving a disabled electric vehicle thereon with a winch and a ramp for transportation of the disabled electric vehicle, the rescue vehicle include the mobile platform comprising the winch and the ramp; and
recharging the disabled electric vehicle with a charging unit associated with the mobile platform during a transportation of the disabled electric vehicle on the mobile platform, wherein the rescue vehicle comprises at least one of an autonomous vehicle, a semi-autonomous vehicle, or a non-autonomous vehicle.

19. The method of claim 18, wherein the rescue vehicle is adapted to carry passengers associated with the disabled electric vehicle as the disabled electric vehicle is being charged by the charging unit during the transportation of the disabled electric vehicle on the mobile platform.

20. The method of claim 18, wherein the rescue vehicle comprises at least one of: an electric vehicle, a truck, or an aircraft.
